(19) United States
(12) Patent Application Publication
(10) Pub. No.: US 2008/0257330 A1
(43) Pub. Date: Oct. 23, 2008

(54) IMPACT BLOCK SPLITTER

(76) Inventors: Louis HEBERT, Saint-Urbain-Premier (CA); Ian HAVILL, Mascouche (CA)

Correspondence Address: OGILVY RENAULT LLP, 1981 MCGILL COLLEGE AVENUE, SUITE 1600, MONTREAL, QC, H3A2Y3, CA

(21) Appl. No.: 12/107,287

(22) Filed: Apr. 22, 2008

(30) Foreign Application Priority Data
Apr. 23, 2007 (CA) 2,585,693

(51) Int. Cl. B28D 1/26; B28D 1/32

(52) U.S. Cl. 125/23.01; 173/114; 173/131

(57) ABSTRACT

An impact block splitter and a method of splitting casted concrete blocks is described. The impact block splitter is comprised of a cylindrical housing with a splitting blade secured to a lower end of the cylindrical housing. The splitting blade has an impact receiving rear end projecting inside the cylindrical housing. An impact element is displaceably mounted behind the impact receiving rear end of the spitting blade inside the housing. The cylindrical housing is displaceable axially to a downward position wherein the splitting blade is positioned on a surface of a block to be split. A pneumatic control system actuates the impact element to project it in a downward motion against the impact receiving rear end of the splitting blade to impart a blow thereto and to also cause the impact element to be retracted in an upward motion.

### TECHNICAL FIELD

The present invention relates to an impact block splitter for splitting concrete casted blocks and to the method of operation thereof.

### BACKGROUND ART

In the fabrication of concrete casted blocks for use as pavers, retaining walls, and all sorts of stone-like structures, in order to fabricate blocks which have a surface which closely resemble real stone, these blocks are split along straight lines whereby to expose the aggregate in the concrete in a surface of the block. This exposed aggregate results in a roughened surface resembling real stone. Such block splitting is usually effected by first casting a V-notched groove across a top face of a concrete block in an area where the block is to be split. A splitting blade is then positioned in the groove and a blow is imparted to the blade by suitable means, such as a hammer.

In our U.S. Pat. No. 7,077,121, issued on Jul. 18, 2006, entitled IMPACT BLOCK SPLITTER, there is described a machine for splitting casted concrete blocks. As therein illustrated, these machines are very bulky and therefore occupy a large area for splitting precasted concrete stones which are positioned under the machine on a platform at a precise location. Because of the large space occupied by such machines there is a limitation on the number of machines that can be installed and therefore the number of concrete casted blocks that may be split during one machine operation. Further, if one of the block splitters becomes defective, this often idles the entire machine set-up until that particular splitter machine is replaced or repaired. Such downtime is costly to the fabrication of these stories. Further, because these machines have many moving parts which are exposed to the environment wherein there is a substantial amount of dust in the air, they are prone to malfunction and rapid wear of its moving connections. These machines are also hazardous to personnel due to their many moving parts that are exposed and which are in motion. Such machines are also not easily adaptable for integration at positions over or alongside a conveyor line, as they are too bulky. Their operating cycle is also considered slow.

### SUMMARY OF INVENTION

It is a feature of the present invention to provide an impact block splitter which substantially overcomes the above-mentioned disadvantages of the referred to impact block splitter machine.

Another feature of the present invention is to provide a method of splitting casted concrete blocks which substantially overcomes the above-mentioned disadvantages of the prior art.

Another feature of the present invention is to provide an impact block splitter which is compact in construction, which can be easily adapted to existing concrete block manufacturing processes, and which can be easily arid quickly secured in a block splitter fabrication line and which, can be easily interchanged in the event of malfunction.

Another feature of the present invention is to provide an impact block splitter wherein the moving parts of the splitter are protected in a sealed housing.

Another feature of the present invention is to provide an impact block splitter which is operated by pneumatic control means and wherein the blade is actuatable by a single control signal and which is controllable by a computer program to modify its operating parameters.

According to the above features, from a broad aspect, the present invention provides an impact block splitter which comprises a cylindrical housing with a splitting blade secured to a lower end of the cylindrical housing. The splitting blade has an impact receiving rear end projecting inside the cylindrical housing. An impact element is displaceably mounted behind the impact receiving rear end of the spitting blade. Means is provided to displace the cylindrical housing axially to a downward position wherein the splitting blade is positioned on a surface of a block to be split. Actuating control means is further provided to cause the impact element to be projected in a downward motion against the impact receiving rear end of the splitting blade to impart a blow thereto and to also cause the impact element to be retracted in an upward motion.

According to a further broad aspect of the present invention there is provided a method of splitting casted concrete blocks. The method comprises the steps of

positioning a casted concrete block below an impact block splitter, as above described, said casted concrete block being aligned with a splitting blade of the impact block splitter whereby said blade is above a predetermined location on a top surface of the casted concrete block. The cylindrical housing is lowered to position the splitting blade at the predetermined location on the top surface of the casted concrete block. An impact element inside the cylindrical housing is projected to impact onto a rear end of the splitting blade to split the concrete casted block. The impact element is then retracted inside the cylindrical housing and the cylindrical housing is then retracted.

### BRIEF DESCRIPTION OF DRAWINGS

A preferred embodiment of the present invention will now be described with reference to the accompanying drawings in which:

FIG. 1 is a sectional side view of the impact block splitter of the present invention showing the cylindrical housing in a retracted position;

FIG. 2 is a section view similar to FIG. 1, but showing the cylindrical housing in a lowered position.;

FIG. 3 is an enlarged sectional view of the spool valve section of the impact block splitter which controls the operation of the impact element and herein showing the position of the spool with the impact element in a retracted standby position;

FIG. 4 is a view similar to FIG. 3 showing the position of the spool valve for displacing the impact element for impact onto the splitting blade; and

FIG. 5 is a perspective view showing a plurality of impact block splitters supported on a frame under which there is positioned a plurality of precast concrete blocks to be split.

### DESCRIPTION OF PREFERRED EMBODIMENTS

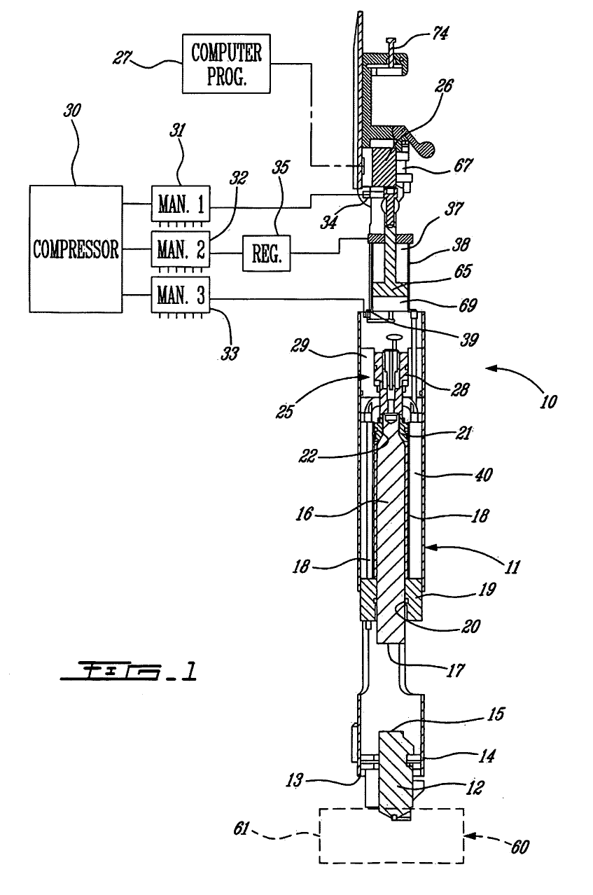

Referring now to the drawings, and more specifically to FIG. 1, there is shown generally at 10 the impact block splitter of the present invention. It is comprised of a cylindrical housing 11 in which there is secured a splitting blade 12 at a lower end 13 thereof. The blade 12 is secured to the lower end of the cylindrical housing by lock rings 14. The splitting blade 12 is also provided with a flat impact receiving rear end 15 inside the cylindrical housing.

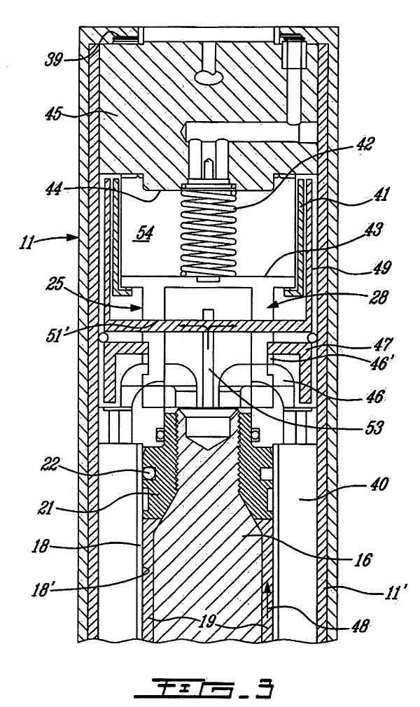

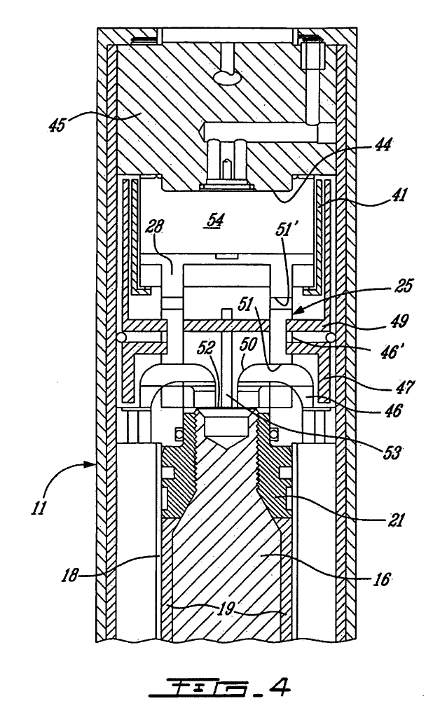

As hereinshown, an elongated cylindrical impact element 16 is displaceably mounted behind and above the impact receiving rear end 15 of the splitting blade 12. This impact element 16 is a solid cylindrical steel rod having a lower contact impacting surface 17 . The impact element 16 is displaceable in a cylindrical casing 18 and spaced from an inner cylindrical wall 18′ thereof, as better shown in FIGS. 3 and 4, whereby to define a surrounding air chamber 19 about the impact element. The impact element is guidingly displaceable in the cylindrical casing 18 by a lower bushing 19 provided with an annular ring 20 about the cylindrical impact element 16. A collar bushing 21 is and secured about a top end of the impacting element and also provided with an annular ring 22 as better illustrated in FIGS. 3 and 4.

An actuating spool assembly 25 is mounted in the cylindrical housing 11 at a top end of the impacting element 16 to control the movement thereof thereby causing the impact element 16 to be projected in a downward motion against the impact receiving rear end 15 of the splitting blade whereby to impart a blow thereto. This actuating spool assembly 25 also causes the impact element to be retracted in an upward motion to its standby position, as illustrated in FIG. 1.

The actuating spool assembly 25 is operated by a pneumatic system which includes an air valve controller in the form of an airbox 26 which airbox has a valve operated by a signal and the operating cycle of which is configured by a computer, herein schematically illustrated at 27, provided with a program to set the positioning of the cylindrical housing 11, as will be described later, and the sequence of operation of the impacting element 16. This airbox is coupled to a spool valve 28 of the assembly 25 which is displaceable in a spool valve block 29 which is provided with conduits therein and schematically illustrated in FIGS. 3 and 4, to channel compressed air to operate the spool valve 28 as well as the impacting element 16.

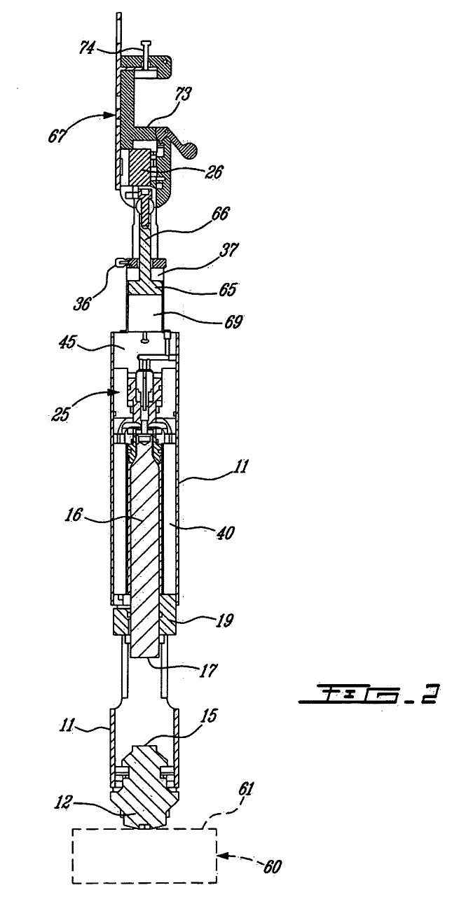

A compressor 30 provides the compressed air supply to the impact block splitter or a plurality of splitters. As hereinshown the compressor 30 has three manifolds 31, 32 and 33 with manifold 31 being connected to the air hose connector 34 of the airbox controller 26. Manifold 32 has its output connected to a pressure regulating valve 35 and connects to the hose connector 36 as shown in FIG. 2 to provide air supply to an air pressure chamber 37 of a piston chamber 38 secured at a top end of the cylindrical housing whereby to provide a means to displace the cylindrical housing axially to a downward position wherein, the splitting blade 12 is positioned on a surface of a block to be split, and to retract the cylindrical housing. The operation of this piston chamber will be described later in detail. The third manifold 33 is secured to a hose connector 39 (see FIG. 3) to provide a pressurized air supply to an air supply chamber 40 delineated about the cylindrical casing 18 and between the cylindrical housing outer wall 11.

With additional reference now to FIGS. 3 and 4, there will be described the operation of the spool valve 28. The airbox valve 26 is in communication with the spool valve 28 to cause the spool valve to open. The spool valve block 29 is not shown in FIGS. 3 and 4, for clarity, but it is provided with a communication conduit. 41 coupled with the airbox 26. As shown in FIG. 3, when the spool 28 is biased in a lowered closed or standby position by the helical spring 42 mounted between a top wall 43 of the spool and a solid top wall 44 of the cylindrical bushing 45. The spring 42 pushes the spool 28 downwardly in the absence of pressurized air in the conduit 41 from the airbox valve 26. In the closed position, the spool valve communicates air from the air supply chamber 40 through, a conduit 46, an intermediate conduit 46′ in the valve block and to a further conduit 47 which is in communication with the surrounding air chamber 19 about the impacting element 16. This provides a supply of air pressure into the surrounding air chamber acting upwards in the direction of arrow 48 against the collar bushing 21 maintaining the impacting element biased upwardly within the cylindrical casing 18. Accordingly, the impacting element 16 is in a standby retracted position. Conduit 49 is an air evacuation conduit and it connects to the exterior of the cylindrical housing 19 at an appropriate location, not shown herein.

Referring now to FIG. 4, there is shown the spool 28 in its upwardly biased open position with air pressure having been provided in the conduit 41 by the airbox 26. The pressure from manifold 31 is greater than the spring force of the helical spring 42, In this position it can be seen that the conduit 47, which connects to the surrounding air chamber 19, is placed in communication with the air evacuation conduit 49 to evacuate air from the surrounding chamber 19. Also, the conduit 46 is now communicated with a further conduit 50 through the port 51 of the spool valve whereby air under pressure; from the air supply chamber 40 acts onto the top wall 52 of the impacting element 16 to quickly drive the impact element downwardly.

Because the surrounding air chamber has now been evacuated to atmosphere through the air evacuating conduit 49, there is no resistance on the displacement of the impacting element 16 within the cylindrical casing 18. Accordingly, the impacting surface 17 of the impacting element 16 strikes the impact receiving rear end 15 of the splitting blade 12. This causes the splitting blade 12 to transmit the blow onto a concrete casted block 60 positioned thereunder (schematically illustrated in FIG. 2) and wherein the splitting blade 12 has been positioned to rest on a top surface 61 thereof. This imparted blow on the splitting blade 12 is sufficient to split the precast concrete block along a notch line. The vibration caused by the impact on the splitting blade is absorbed by the cylindrical housing 11. The airbox pressure signal is a momentary air pressure signal and accordingly after the airbox returns to its initial position the spool returns to its position as shown in FIG. 3 wherein the spring 42 moves the spool downward to its closed position disconnecting the port 51 from the air supply chamber 40 which is now connected to the surrounding air chamber 19 below the collar bushing 21 causing the impacting element to move quickly upwardly and in its upward movement exhausting air from above the collar bushing 21 via exhaust conduit 53 and the air evacuating conduit 49 through valve ports 51′.

In FIG. 4 the helical spring 42 is not shown, but it is pointed out that instead of a helical spring the pressure in the top chamber 54 could be provided by means of an air pressure supply. The advantage of having the helical spring 42 is that in the event that the air pressure signal is lost from the airbox due to a compressor malfunction or loss of power, then this helical spring 42 would cause the spool valve 28 to close to assume its position as shown in FIG. 3 whereby the impacting element 16 remains in its retracted standby position.

As previously described and with reference again to FIGS. 1 and 2, the cylindrical housing 11 is axially displaceable by a cylindrical piston chamber 38, the casing 38′ or which is secured at a top end of the cylindrical housing 18. This cylindrical piston chamber 38 is provided with a stationary piston head 65 provided with a piston rod end 66 which is secured to a stationary member, herein a lower end of an attachment coupling 67 thereby maintaining the piston head 65 stationary. The cylindrical piston chamber 38 defines an air pressure chamber 37 on a top side of the piston head 65, and an air control chamber 69 on the lower side of the piston head 65. The air control chamber 69 is connected to the airbox 26 which is controlled by the computer 27 as previously described. It causes the airbox 26 to supply air under pressure from manifold 31 and which overcomes the air pressure on the air pressure chamber 37 which returns to the manifold 32 through the pressure regulating valve 35.

The cylindrical housing is in a retracted position as shown in FIG. 1 when the control chamber is non-pressurized. As soon as the air control chamber 69 becomes pressurized, the cylindrical housing 11 is caused to move downwardly by the air pressure under the piston head 65 pushing against the piston, head 65 and moving the casing 38′ connected to the cylindrical bushing 45 at the top end of the cylindrical, housing downwardly to position the blade 12 against the top surface 61 of the casted concrete block 60 therebelow to be split. The air pressure force in the control chamber 69 is set whereby as soon as the splitting blade 12 rests on the top surface 61 of the block 60 the resistance thereof overcomes the air pressure in the control chamber 69 and arrests the descending motion of the cylindrical casing. Accordingly, this block splitter is self-adjusting to the thickness of the block to be impacted. The air regulator 35 from the second manifold provides this constant air pressure to the air control chamber 69 and such, is sufficient to displace the cylindrical housing 11 but insufficient to apply a block splitting force.

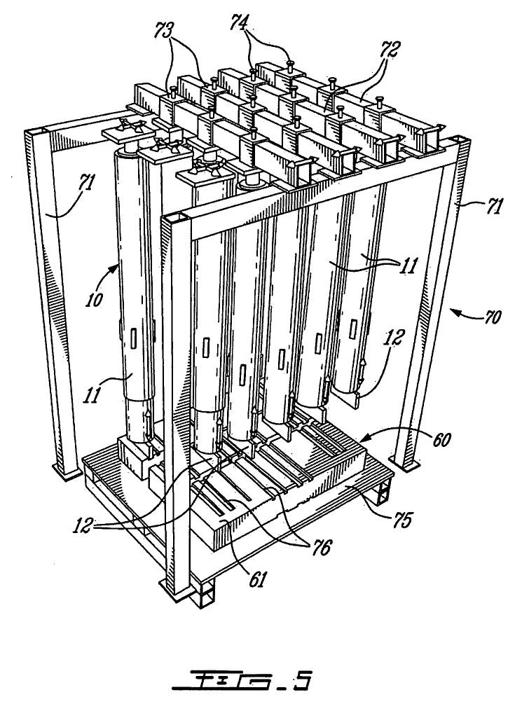

Referring now to FIG. 5, there is shown a support frame structure 70 provided with support posts 71 and horizontal support beams 72 to which is removably secured a plurality of impact block splitters 10. As shown three block splitters 10 are secured to the horizontal support beams 72 by its attachment coupling 67. As better illustrated in FIGS. 1 and 2, these couplings 67 are provided with a U-shaped clamp 73 to receive a horizontal support beam 72 therein. A securing bolt 74 immovably secures the clamp to the beam 72. These impact block splitters 10 are positioned at predetermined locations and extend vertically downwardly therefrom. They are adjustable along the beams 72.

As hereinshown, a plurality of concrete casted blocks 60 are disposed at a precise location on a support steel plate 75 whereby the parting slots 76 in the top wall 61 of the blocks 60 are in alignment with the splitting blades 12 of the impact block splitters 10. Once in this position the cylindrical housings 11 are lowered in unison, as previously described, to position the splitting blades 12 at the predetermined locations on the top surfaces of these casted concrete blocks and namely in the parting slots 76. The impact element inside the cylindrical housing is then released to impact on the splitting blade 12 and split all of these concrete casted blocks 60 substantially at the same time. The splitting is done in a split second. The cylindrical housings are then retracted and the support plate 75 removed and a new support plate with casted blocks is placed in position. This support plate 75 is the plate on which these concrete casted blocks are formed and cured. Accordingly, the concrete casted blocks 60 are never removed from the support plate 75 during its transportation from the curing area to the block splitting station. After the blocks are split the support plate 75 is transported to a sorting or block packaging station.

It is pointed out that with the airbox and spool valve design, a single signal is sufficient to the airboxes to cause the airboxes to operate their associated spool valves in the system all in substantial synchronism causing each of the cylindrical housings to descend and to then release the impacting element to impart a blow to the splitting blade to split the blocks and to then cause the impacting element to retract while simultaneously retracting the cylindrical housings. It is pointed out that because of the compact cylindrical design of the impact block splitter 10 such occupies very little surface area space. Also, the splitter(s) could be adapted directly over a conveyor station where the one or more blocks are arrested at a precise location and orientation for splitting.

It is within the ambit of the present invention to cover any obvious modifications of the preferred embodiment described herein provided such modifications fall within the scope of the appended claims.

We claim:

1. An impact block splitter comprising a cylindrical housing, a splitting blade secured to a lower end of said cylindrical housing, said splitting blade having an impact receiving rear end projecting inside said cylindrical housing, an impact element displaceably mounted behind said impact receiving rear end of said spitting blade, means to displace said cylindrical housing axially to a downward position wherein said splitting blade is positioned on a surface of a block to be split, actuating control means to cause said impact element to be projected in a downward motion against said impact receiving rear end of said splitting blade to impart a blow thereto and to also cause said impact element to be retracted in an upward motion.

2. An impact block splitter as claimed in claim 1 wherein said actuating control means is a pneumatic control means.

3. An impact block splitter as claimed in claim 2 wherein said pneumatic control means comprises an air valve control coupled to a spool valve to cause said spool valve to channel air under pressure to operate said impact element and to exhaust air.

4. An impact block splitter as claimed in claim 3 wherein said air valve control is an airbox connected to a pressurized air supply and coupled to said spool valve through a valve to cause said spool valve to be momentarily displaced to an open position wherein air under pressure from an air supply chamber biases said impact element in a descending impacting motion, said spool valve being displaced to a closed position by air under pressure from said air supply chamber.

5. An impact block splitter as claimed in claim 4 wherein said spool valve is displaceably supported in said cylindrical housing above said rear end of said impact element and spaced from a rear solid wall of said cylindrical housing to define a top chamber, and compressible biasing means in said to chamber to maintain said spool in a downwardly biased position when said pressurized air supply is absent from said airbox to retain said impact element retracted and said spool valve at said closed position.

6. An impact block splitter as claimed in claim 6 wherein said compressible biasing means is a helical spring compressed between said spool valve and said rear solid wall of said cylindrical housing.

7. An impact block splitter as claimed in claim 5 wherein said spool valve when in said open position exhausts air from a surrounding air chamber about said impact element through an exhaust port, and when in said closed position said air under pressure from said air supply chamber is channeled to said surrounding air chamber air behind a top end of said impact element is exhausted.

8. An impact block splitter as claimed in claim 4 wherein said impact element is an elongated solid cylindrical steel rod having a lower contact impacting surface, said steel rod being displaceable in a cylindrical casing and spaced from an inner cylindrical wall thereof to define said surrounding air chamber about said steel rod, seal means in said inner cylindrical wall about said steel rod at opposed ends of said surrounding air chamber, said surrounding air chamber communicating with said air supply-chamber through air conduit means.

9. An impact block splitter as claimed in claim 1 wherein said means to displace said cylindrical housing axially is a piston cylinder secured at a top end of said cylindrical housing.

10. An impact block splitter as claimed in claim 9 wherein said piston cylinder is a cylindrical piston chamber having a stationary piston head therein provided with a piston rod secured to a stationary member, said cylindrical piston chamber on a top side of said piston head defining an air pressure chamber, and an air control chamber on a lower side of said piston head, said air control chamber being connected to an air pressure regulating valve, said cylindrical housing being in a retracted position when said control chamber is non-pressurized, said air control chamber when pressurized through said air regulating valve displacing said cylindrical housing to said downward position.

11. An impact block splitter as claimed in claim 10 wherein said air regulating valve is connected to a manifold connected to said pressurized air supply.

12. An impact block splitter as claimed in claim 11 wherein a further manifold of said pressurized air supply is connected to said airbox of said actuating control means, and a still further manifold is connected to an air supply chamber providing pressurized air to operate said impact element.

13. An impact block splitter as claimed in claim 1 wherein said cylindrical housing is provided, with, attachment means in a top portion thereof to secure said impact block splitter to a support frame with said impact block splitter depending vertically therefrom.

14. An impact block splitter as claimed in claim 13 wherein a plurality of said impact block splitters are secured to said support frame at predetermined locations whereby to split a plurality of concrete casted blocks positioned thereunder.

15. An impact block splitter as claimed in claim 14 wherein said concrete casted blocks are positioned at a precise location on a support plate precisely aligned under said plurality of impact block splitters.

16. A method of splitting casted concrete blocks comprising the steps of:
i) positioning a casted concrete block below an impact block splitter according to claim 1, said casted concrete block being aligned with a splitting blade of said impact block splitter whereby said blade is above a predetermined location on a top surface of said casted concrete block;
ii) lowering a cylindrical housing of said impact block splitter to position said blade at said predetermined location on said top surface of said casted concrete block;
iii) projecting an impact element inside said cylindrical housing to impact onto a rear end of said splitting blade to split said concrete casted block;
iv) retracting said impact element inside said cylindrical housing; and
v) retracting said cylindrical housing.

17. A method as claimed in claim 16 wherein said step (ii) comprises the steps of pressurizing an air control chamber below a stationary piston head of a piston cylinder secured at a top end of said cylindrical housing to cause said piston cylinder an said cylindrical housing to move downwardly to position said splitting blade at said predetermined location.

18. A method as claimed in claim 16 wherein said step (iii) comprises operating a spool valve to channel air under pressure from an air supply chamber onto a rear end of said impact element to project said impact element downwards to impact against a rear end of said splitting blade while evacuating air within a surrounding chamber about said impact element.

19. A method as claimed in claim 18 wherein said step (iv) comprises operating said spool valve to pressurize said surrounding chamber with air from said air supply chamber to displace said impact element upwards and evacuate air from above said rear end of said impact element.

20. A method as claimed in claim 15 wherein there is provided a plurality of said impact block splitters secured to a support frame with said impact block splitters depending vertically therefrom at predetermined positions, and wherein there is further provided the step of positioning a support: plate with, a plurality of casted concrete blocks positioned at a precise location thereon, said support plate being positioned, at a precise position with said plurality of said impact block splitters.
